(19) United States
(12) Patent Application Publication
(10) Pub. No.: US 2010/0225578 A1
(43) Pub. Date: Sep. 9, 2010

(54) Method for Switching Multi-Functional Modes of Flexible Panel and Calibrating the Same

(76) Inventor: Chueh-Pin Ko, Hsichih (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/605,507

(22) Filed: Oct. 26, 2009

(30) Foreign Application Priority Data
Mar. 3, 2009 (TW) 098106890
Mar. 3, 2009 (TW) 098106891

(51) Int. Cl. G09G 5/00; G06F 3/041

(52) U.S. Cl. 345/156; 345/173; 340/686.1

(57) ABSTRACT

A method for switching multi-functional modes and calibrating an electronic device and the electronic device using the method are disclosed. The method for switching multi-functional modes comprises: detecting at least one sensing device to identify a specific shape of a flexible panel of the electronic device; and matching the specific shape with the multi-functional modes according to a corresponding table so as to execute one specific functional mode. The corresponding table comprises a corresponding relationship between the specific shapes of the flexible panel and the specific functional modes, and a specific functional mode executed by the electronic device corresponds to the specific shape according to the corresponding relationship.

### BACKGROUND OF THE INVENTION

1. Field of the Invention

The present invention relates to a method for switching multi-functional modes and an electronic device using the method; and more particularly, to a method for switching multi-functional modes for executing a different functions in each mode when a flexible panel is bended to form a specific shape, and for calibrating the flexible panel.

2. Description of the Related Art

Traditional display panels are made of rigid materials and cannot be bended; therefore, they can only provide display functions for electronic devices. A touch screen or a display panel with a touch screen function can control for functions of an electronic device through the touch panel; however, the touch screen is also rigid and cannot be bended to form other shapes.

Currently, more flexible display panels are emerging; however, they can only provide display functions and flexible shapes, with no other additional capabilities.

It is advantageous for a flexible panel to have other capabilities, such as providing different functions when it is bended to form other shapes. However, due to its flexibility, the sensing function of the flexible panel must be carefully calibrated to meet practical demands and conditions.

### SUMMARY OF THE INVENTION

It is an object of the present invention to provide an electronic device which can be bended to form different shapes to change or to execute specific functional modes.

It is another object of the present invention to provide a method for calibrating a flexible panel.

In order to achieve the above objects, the present invention provides a method for switching multi-functional modes, which comprises the following steps: detecting at least one sensing device to identify a specific shape of a flexible panel of an electronic device; and matching the specific shape with the multi-functional modes according to a corresponding table so as to execute a specific functional mode, wherein the corresponding table comprises a corresponding relationship between the specific shape of the flexible panel and the specific functional mode, and the specific functional mode executed by the electronic device corresponds to the specific shape according to the corresponding relationship.

In one embodiment, the method further comprises the following steps: receiving a first sensing value from at least one sensing device when the flexible panel is bended to form the specific shape; matching the first sensing value with a reference table; and sending a calibrating signal according to the reference table so as to execute the specific functional mode according to the calibrating signal.

In an embodiment of the present invention, the method for switching the multi-functional modes comprises the following steps: determining if the electronic device is in the specific shape for a specific period; if “yes”, then matching the specific shape with the corresponding table so as to execute a specific functional mode according to the specific shape; if “no”, then repeating the step of detecting the sensing device to identify the specific shape of the flexible panel of the electronic device.

The present invention further provides an electronic device comprising a flexible panel, at least one sensing device, a storage device, and a processor, wherein the flexible panel is capable of forming a specific shape; the sensing device is electrically coupled with the flexible panel, and the sensing device is provided for detecting the specific shape of the flexible panel; the storage device is electrically coupled with the flexible panel and the sensing device, and the storage device stores a corresponding table comprising a corresponding relationship between the specific shape of the flexible panel and a specific functional mode; and the processor is electrically coupled with the sensing device and the storage device to execute the specific functional mode.

Hence, when the flexible panel is bended to form the specific shape, the processor is executed to match the specific shape with the corresponding table so as to execute the specific functional mode corresponding to the specific shape.

### BRIEF DESCRIPTION OF THE DRAWINGS

FIG. 1 illustrates a functional block diagram of an electronic device of an embodiment of the present invention.

FIG. 2 illustrates a corresponding table of the electronic device in an embodiment of the present invention.

FIG. 3 to FIG. 6 illustrate sensing devices disposed on the electronic device in accordance with various embodiments of the present invention.

FIG. 7A to FIG. 7C illustrate views of a specific shape of a flexible panel of the electronic device in an embodiment of the present invention;

FIG. 7D illustrates a reference table describing specific shapes with respect to a flexible panel.

FIG. 8 and FIG. 9 illustrate an electronic device having different touch regions in accordance with embodiments of the present invention.

FIG. 10 illustrates a flow chart of a method for switching multi-functional modes.

FIG. 11 illustrates a 3D view of an electronic device in accordance with one of the embodiments of the present invention.

FIG. 12 illustrates a flowchart of a method for calibrating a flexible panel in one of the embodiments of the present invention.

FIG. 13 illustrates a part of the flows of a method for calibrating a flexible panel in a preferred embodiment of the present invention.

FIG. 14A and FIG. 14B illustrate a flexible panel formed in a specific shape with overlapping parts.

FIG. 15 illustrates another flowchart of a method for calibrating a flexible panel in accordance with another embodiment of the present invention.

### DETAILED DESCRIPTION OF THE PREFERRED EMBODIMENT

The advantages and innovative features of the invention will become more apparent from the following detailed description when taken in conjunction with the accompanying drawings.

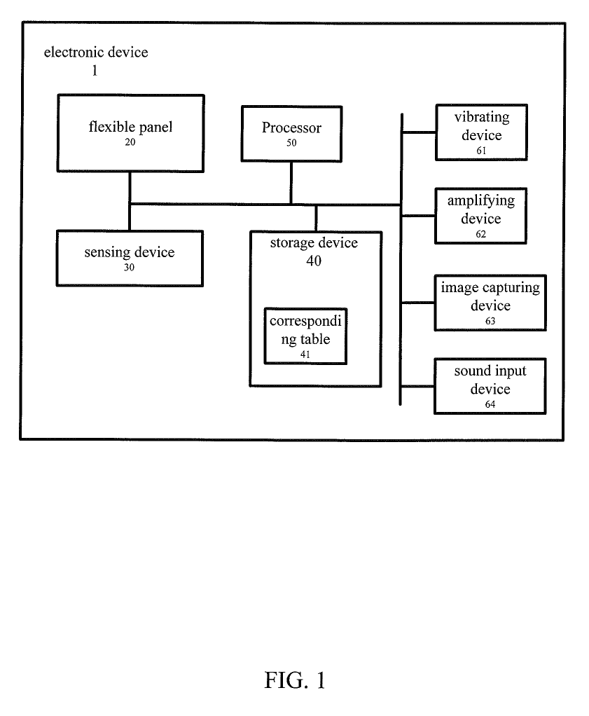

Please refer to FIG. 1 for a block diagram of an electronic device of an embodiment of the present invention.

In the embodiment of the present invention, an electronic device 1 comprises a flexible panel 20, a sensing device 30, a storage device 40 and a processor 50. The flexible panel 20 can be bended to form a specific shape. The sensing device 30 is electrically coupled with the flexible panel 20. The sensing device 30 is used for detecting the specific shape of the flexible panel 20; that is, the sensing device 30 can identify different shapes of the flexible panel 20. The storage device 40 is electrically coupled with the flexible panel 20 and the sensing device 30. The storage device 40 stores a corresponding table 41 comprising a corresponding relationship between the specific shapes of the flexible panel 20 and the specific functional modes of the electronic device 1 (which will be described below in more detail). The processor 50 is electrically coupled with the sensing device 30 and the storage device 40. The electronic device 1 executes a specific functional mode according to the corresponding table 41. Furthermore, when the flexible panel 20 is bended to form a specific shape, the processor 50 refers to the corresponding table 41 to execute a specific functional mode corresponding to the specific shape (which will be described below in more detail).

Preferably, the flexible panel 20 is a flexible display panel, such as a flexible display, a liquid crystal display (LCD), an organic light emitting diode (OLED) display, an E-paper or a transparent display.

In an embodiment of the present invention, the electronic device 1 further comprises a vibrating device 61, an amplifying device 62, an image capturing device 63, or a sound input device 64 electrically coupled with the processor 50 respectively. The vibrating device 61, the amplifying device 62, the image capturing device 63, or the sound input device 64 cooperate with the electronic device 1 when executing one specific functional mode; however, the present invention is not limited to these devices described above.

The specific shapes can, for example, comprise a plane, an U shape, an arc, a corrugated shape, a cylindrical shape, or a bended shape with a specific angle; however, the present invention is not limited to these shapes described above.

In an embodiment of the present invention, the specific functional modes comprises a keyboard mode, a mouse mode, a TV mode, a PC monitor mode, a clock mode, a digital frame mode, or a mobile phone mode, but the present invention is not limited to the modes described above and can comprise any functions provided by any electronic devices. The specific functional modes also include a graphic user interface being changed according to the specific shape of the flexible panel.

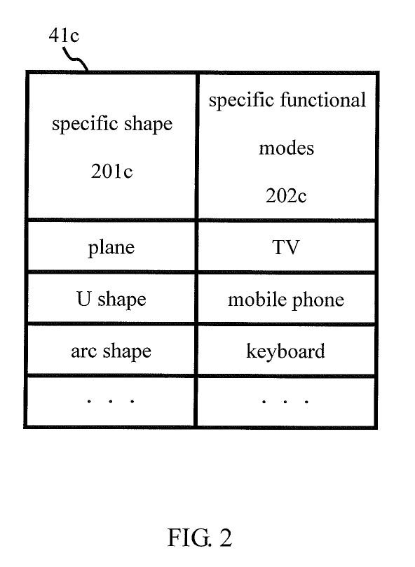

Please refer to FIG. 2; for example, the corresponding table 41c comprises a corresponding relationship between the specific shapes 201c of the flexible panel 20 and the specific functional modes 202c of the electronic device 1. In an embodiment of the present invention, when the specific shape of the flexible panel 20 is detected to be a plane, then according to the corresponding table 41c, the specific functional mode executed by the electronic device 1 is a TV function; accordingly, the electronic device 1 acts as a TV. According to the corresponding table 41c in FIG. 2, when the specific shape of the flexible panel 20 is detected to be a U shape, the specific functional mode executed by the electronic device 1 is a mobile phone function. Additionally, according to the corresponding table 41c in FIG. 2, when the specific shape of the flexible panel 20 is detected to be an arc shape, the specific functional mode executed by the electronic device 1 is a keyboard function; that is, the electronic device 1 acts as a keyboard.

When the flexible panel 20 of the electronic device 1 is in a specific shape, or, in other words, the electronic device 1 executes a specific functional mode, the processor 50 outputs a corresponding signal according to the corresponding table 41c to set an output signal value; furthermore, the processor 50 can output different corresponding signals to set different output signal values. It is noted that the corresponding signal is generated based on the bended shape of the flexible panel 20 or other devices included in the electronic device 1, but not necessarily based on the specific functional modes.

For example, when the specific functional mode executed by the electronic device 1 is the TV or the mobile phone function (the U shape corresponding to the mobile phone function, and the plane corresponding to the TV function), there are several setting values for the corresponding signal. As an example, an RGB gain value is set to a default value in the TV mode, and it is set to a default value of +10 in the mobile phone mode. An offset value is set to a default value in the TV mode, and it is set to a default value −5 in the mobile phone mode. A saturation value is set to “medium” in the TV mode, and it is set to “high” in the mobile phone mode. A lightness value is set to “high” in the TV mode, and it is set to “medium” in the mobile phone mode. A contrast value is set to “medium” in the TV mode, and it is set to “high” in the mobile phone mode. A hue value is set to a default value in the TV mode, and it is set to a default value +N in the mobile phone mode. A color temperature value is set to 6,500 K in the TV mode, and it is set to 9,000K in the mobile phone mode. A color gamut value is set to a default value in the TV mode, and it is also set to a default value in the mobile phone mode. A sharpness value is set to “low” in the TV mode, and it is set to “high” in the mobile phone mode. A gamma value is set to 2.2 in the TV mode, and it is set to 2.5 in the mobile phone mode. An aspect ratio value is set to 16:9 in the TV mode, and it is set to 4:3 in the mobile phone mode.

Furthermore, according to the corresponding signal, there are several setting values for a sound output value. A speaker volume is set to “loud” in the TV mode, and it is set to “medium” in the mobile phone mode. A ring tone volume is set to “off” in the TV mode, and it is set to “on” in the mobile phone mode. A boot volume is set to “loud” in the TV mode, and it is set to “medium” in the mobile phone mode. In other words, if the electronic device 1 includes a sound output device (such as the amplifying device 62 shown in FIG. 1), then the processor 50 of the electronic device 1 can automatically generate the corresponding signal as long as the device is in the TV mode, regardless of the bended shape (based on a specific functional mode) of the flexible panel 20. In addition, according to the corresponding signal, there are several setting values for a vibrating device. For example, the vibrating device is set to “off” in the TV mode, and it is set to “on” in the mobile phone mode.

Moreover, there could be several setting values for the corresponding signal. For example, if the input device is a camera, then it is set to “off” in the TV mode, and it is set to “on” in the mobile phone mode. Besides, there are several setting values for a sound input value (based on the corresponding signal); for example, a microphone device is set to “off” in the TV mode, and it is set to “on” in the mobile phone mode.

Besides, different input methods can have different setting values. For example, a touch screen system is set to “enabled for full area” in the TV mode, and it is set to “enabled for partial area” in the mobile phone mode.

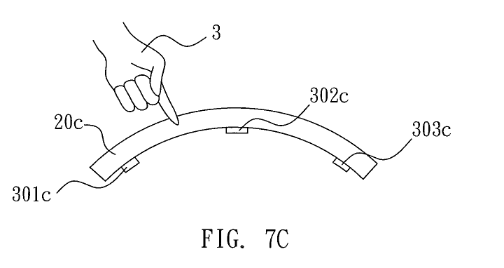

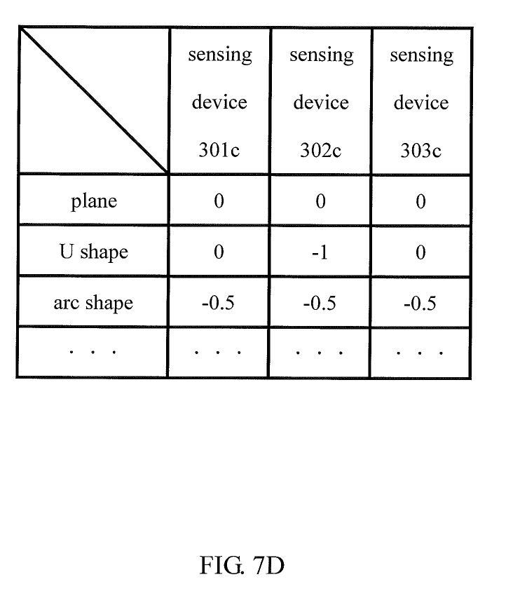

The detection of specific shapes of the flexible panel 20 will be described in FIG. 7A to FIG. 7D in more detail.

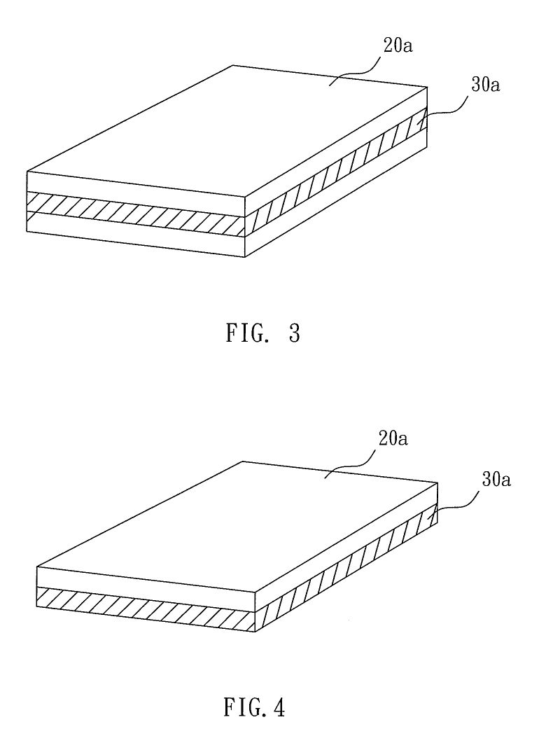

Please refer to FIG. 3 to FIG. 6 for views of sensing devices disposed on the electronic device in various embodiments of the present invention.

In an embodiment of the present invention, a sensing device 30a is disposed inside the flexible panel 20a (as shown in FIG. 3) or on the surface of the flexible panel 20a (as shown in FIG. 4), or any other arrangement. In another embodiment of the present invention, the sensing device 30a is substantially a flexible printed circuit (FPC), but it is not limited thereto. It is noted that the sensing device 30a can be integrated with the flexible panel 20a to become the flexible panel 20a having a sensing device 30a therein.

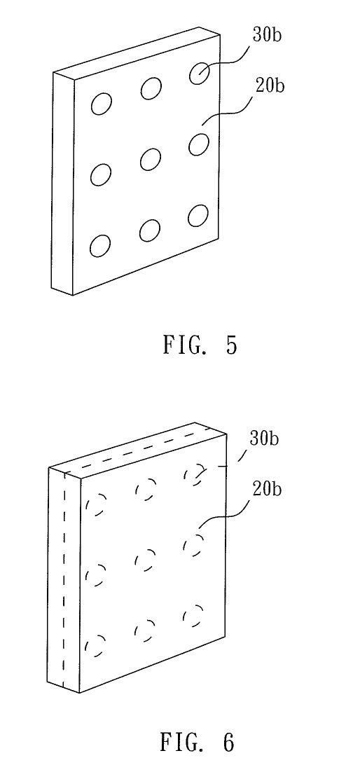

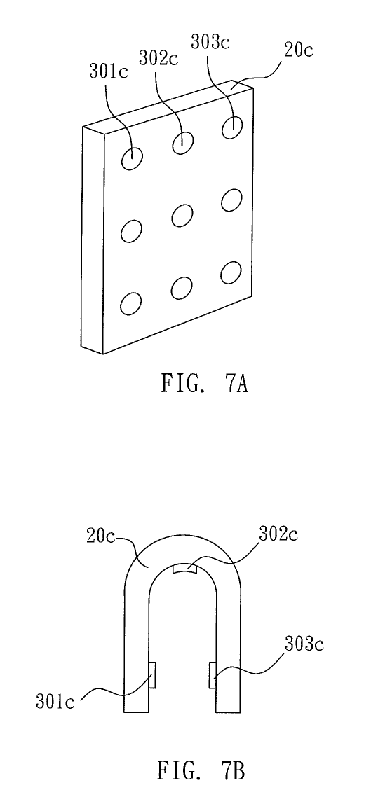

As shown in FIG. 5, in an embodiment of the present invention, the sensing device 30b is a stress sensing device, which determines the specific shapes according to a stress value or an electrical signal generated by the stress (including pressure, compression, strain, shear, etc.), or any other possible measurements. For example, the sensing device 30b can be an optical sensing device or a vibration sensing device. A plurality of sensing devices 30b can be evenly disposed on the surface of the flexible panel 20b or on the inside of the flexible panel 20b (as shown in FIG. 6) or any other place. For example, the sensing devices 30b can be disposed randomly on the flexible panel 20b. Furthermore, the sensing device can be a stress sensing device, wherein the stress sensing device can be a piezoelectric sensing device, a capacitive sensing device (such as converting the size of the contact area into a corresponding stress value), an inductive sensing device, or a resistive sensing device, or any other device which can detect a stress-related value. The above-mentioned sensing devices will not be further described, since they are known in the art. It is noted that the number of the sensing device can be one (as shown in FIG. 3 or FIG. 4) or more than one (as shown in FIG. 5 or FIG. 6) as required.

Please refer to FIG. 7A now for description of the switching of a specific functional mode according to a specific shape of a flexible panel of an electronic device in accordance with an embodiment of the present invention.

As shown in FIG. 7A, in an embodiment of the present invention, the sensing device 301c, the sensing device 302c, and the sensing device 303c are stress sensing devices and are disposed on the flexible panel 20c respectively. Each stress sensing device can detect a stress value or any electrical signal generated by the stress from the flexible panel 20c when the flexible panel 20c is bended so as to determine the shape of the flexible panel 20c. It is noted that the stress value can be expressed in any measurement system (such as psi or KPa).

For example, please also refer to FIG. 7D; when all the sensing devices 301c-303c detect a zero stress value, then the flexible panel 20c is planar.

Please refer to FIG. 7B; when the flexible panel 20c is in a U shape, the sensing device 301c, the sensing device 302c and the sensing device 303c obtain stress values of 0, −1, and 0 respectively; therefore, the specific shape of the flexible panel 20c is in the U shape.

Please refer to FIG. 7C; when the flexible panel 20c is an arc, the sensing device 301c, the sensing device 302c, and the sensing device 303c obtain stress values of −0.5, −0.5, and −0.5 respectively; therefore, the specific shape of the flexible panel 20c is an arc.

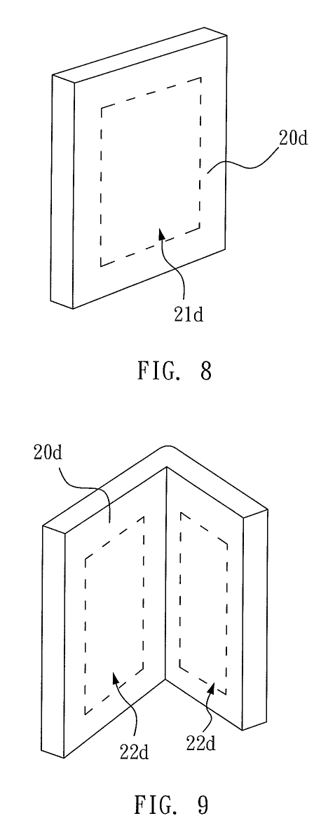

Please refer to FIG. 8 and FIG. 9 now for views of an electronic device having different touch regions in accordance with embodiments of the present invention.

As shown in FIG. 8, for example, a flexible panel 20d comprises a first touch region 21d, wherein the first touch region 21d is disposed on the surface of the flexible panel 20d. The first touch region 21d is provided for touch operations. When a user bends the flexible panel 20d to form an L shape (as shown in FIG. 9), the original touch region is split into a plurality of second touch regions 22d, wherein each second touch region 22d can execute touch functions independently. For example, the original 2-D touch operations up, down, left, and right can be split into two sets of 2-D touch operations including one set of up, down, inward, and outward and another set of up, down, outward, and inward. However, the flexible panel can be bended into different shapes which can divide the first touch region 21d into various regions; therefore, it is not limited to the L shape.

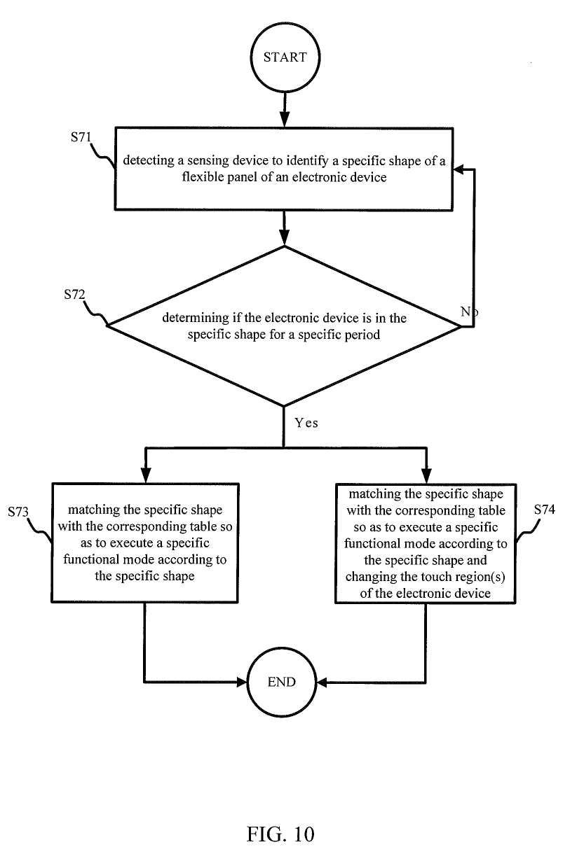

Now please refer to FIG. 10 for a flowchart of a method for switching multi-functional modes.

First, the method goes to step S71: detecting at least one sensing device to identify a specific shape of a flexible panel of an electronic device.

In an embodiment of the present invention, the sensing device can be a stress sensing device or other kind of sensing device.

The sensing device obtains a stress value of the electronic device to detect a specific shape of the electronic device; since different shapes cause different deflections, the sensing device could obtain different stress values. It is noted that the present invention could have sensing devices shown in FIG. 7A to FIG. 7D other than the stress sensing devices; therefore, it will not be further descried.

In an embodiment of the present invention, the specific shape comprises a plane, a U shape, an arc, a corrugated shape, a cylindrical shape, or a bended shape with a specific included angle; however, the present invention is not limited to the above-mentioned shapes.

Preferably, the method proceeds to step S72: determining if the electronic device is in the specific shape for a specific period.

If the determination is “yes”, then the method goes to step S73 or step S74.

If the determination is “no”, then the method repeats at step S71.

In a preferred embodiment of the present invention, in order to prevent erroneous determination of the specific shape of the electronic device in cases such as a user accidentally bending the flexible panel, then a specific period is set; when the sensing device detects the flexible panel of the electronic device is in the specific shape for a specific period (such as 1 to 10 seconds), the method goes to S73; otherwise, the method repeats step S71 and continuously detects the sensing device to detect if the flexible panel has formed a specific shape.

Then the method goes to S73: matching the specific shape with the corresponding table so as to execute a specific functional mode according to the specific shape.

In an embodiment of the present invention, the corresponding table comprises specific shapes, stress values, and specific functional modes (as described above). In an embodiment of the present invention, the specific functional modes can further comprise a keyboard mode, a mouse mode, a digital frame mode, or a PC monitor mode, and any other possible modes.

When the determination in step S72 is “yes”, the method can alternatively go to step S74 instead of S73: matching the specific shape with the corresponding table so as to execute a specific functional mode according to the specific shape and changing the touch region(s) of the electronic device.

In an embodiment of the present invention, if the flexible panel comprises a touch region, the method can go to S74. This will not be further described, as it is already illustrated in FIG. 8 to FIG. 9.

The flexible panel can be an independent input device (such as a keyboard) which transmits a signal to the electronic device (such as a computer host) using wireless or wired transmission techniques.

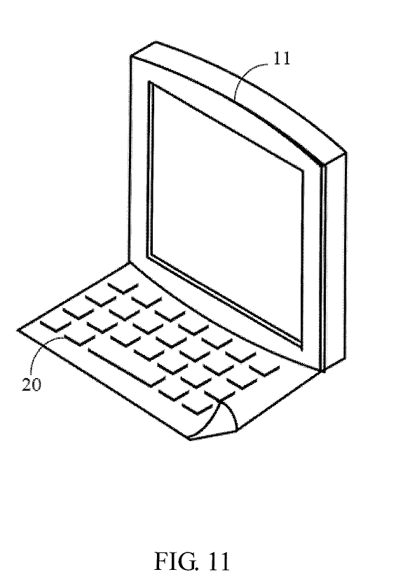

Please refer to FIG. 11; by using the “flexibility” concept, the present invention can further provide an electronic device (such as a notebook PC) to combine a rigid panel 11 (such as a display) with the flexible panel 20 (such as a keyboard) comprising a sensing device or other device (as shown in FIG. 1) to form a flexible notebook PC.

For example, when an included angle between the rigid panel 11 and the flexible panel 20 is 90 degrees, the electronic device executes a specific functional mode as a keyboard for typing in English. When an included angle between the rigid panel 11 and the flexible panel 20 is 135 degrees, the electronic device executes a specific functional mode as a keyboard for typing in Chinese and English. When an included angle between the rigid panel 11 and the flexible panel 20 is 135 degrees with a right corner of the flexible panel 20 bended (as shown in FIG. 11), the electronic device executes a specific functional mode as a joy pad.

Furthermore, the specific shapes shown in the figures are merely for illustration. Take FIG. 7C for example; when the flexible panel is bended to be an arc, the method provides calibration mechanisms to precisely determine whether a finger 3 of the user is executing specific kinds of input operations. Various calibration mechanisms are described below.

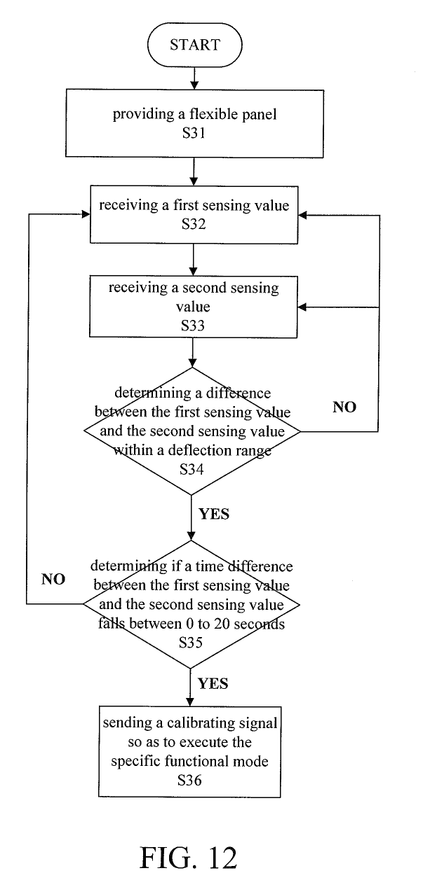

Please refer to the flowchart in FIG. 12; the method goes first to step S31: providing a flexible panel which can be bended to form a specific shape. As shown in FIG. 7A to FIG. 7C, the flexible panel 20c can be bended into various shapes. For the sake of brevity, the flexible panel 20c in FIG. 7C is used for illustrating the flowchart. The flexible panel 20c comprises at least one sensing device, such as the sensing devices 301c-303c. The specific shapes described above can be determined by a stress value or an electrical signal generated by the stress (including pressure, compression, strain, shear, etc.).

Referring back to FIG. 12, the method goes to step S32: receiving a first sensing value. When the flexible panel is bended to form a specific shape, the sensing device detects a first sensing value. Please also refer to FIG. 7C; before the user touches the flexible panel 20c with his/her finger 3, the sensing devices 301c, 302c, and 303c obtain the first sensing values of −0.5, −0.5, and −0.5, respectively, when the flexible panel 20c is bended to form an arc.

Then the method goes to step S33: receiving a second sensing value. After a specific period, the sensing device detects the second sensing value. For example, after a specific period of 0.2 second, since the user's finger 3 has already touched the flexible panel 20c, then the sensing devices 301c, 302c, and 303c obtain the second sensing values of −0.35, −0.4, and −0.5, respectively.

Then the method goes to step S34: determining if a difference between the first sensing value and the second sensing value is within a deflection range. The designer selects the deflection range according to different sensing devices; therefore, there could be different deflection ranges. In the example of FIG. 7C, the deflection range is set to be ±0.2; while the differences between the first sensing values and the second sensing values are 0.15, 0.1, and 0, which are still in the deflection range (±0.2).

In a preferred embodiment of the present invention, the present invention can take a time factor into consideration to improve the decision. Therefore, the present invention further comprises step S35: determining if a time difference between the first sensing value and the second sensing value falls between 0 to 20 seconds; if “yes”, then the method proceeds to step S36. In other words, if the time difference between the first sensing value and the second sensing value is too long, then the first sensing value is invalid, so when the decision is “no” in step S35, the method returns to step S32: receiving the first sensing value once again.

Then the method goes to step S36: sending a calibrating signal so as to execute the specific functional mode (as shown in FIG. 7A to FIG. 7C) according to the calibrating signal. If the difference between the first sensing value and the second sensing value exceeds the deflection range, which means it is not a “normal” touch operation, the flow returns to step S33 to receive the second sensing value once again.

Alternatively, in another embodiment of the present invention, if the difference between the first sensing value and the second sensing value exceeds the deflection range, the flow returns to step S32 to receive the first sensing value once again.

As in the example in FIG. 7C, since the sensing devices 301c, 302c, and 303c have differences of 0.15, 0.1, and 0, respectively, the stress point and the strength of the stress (generated by the pressure of the user's finger 3) can be obtained, such as the touch point being in the left touch region with an offset of two centimeters to the right, and the stress being Level 3 (which is only illustrative; the present invention can have other sensing devices and other reference tables). Therefore, the processor in the present invention can cause the electronic device 1 to execute the specific functional mode according to the calibrating signal.

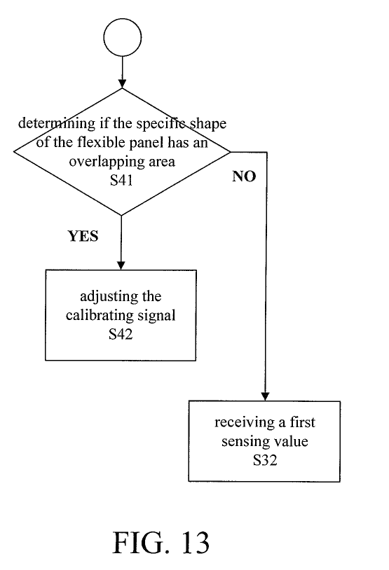

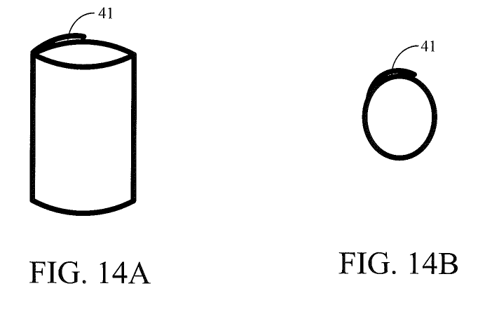

Please refer to FIG. 13; in another preferred embodiment of the present invention, the method can further proceed to step S41: determining if the specific shape of the flexible panel has an overlapping area; and if “yes”, then adjusting the calibrating signal (step 42). Please refer to both FIG. 14A and FIG. 14B (FIG. 14B is a top view of FIG. 14A); if the flexible panel is bended to form a overlapping area 41, then the sensitivity of the overlapping area 41 should be different from other areas; therefore, it is necessary to adjust the calibrating signal.

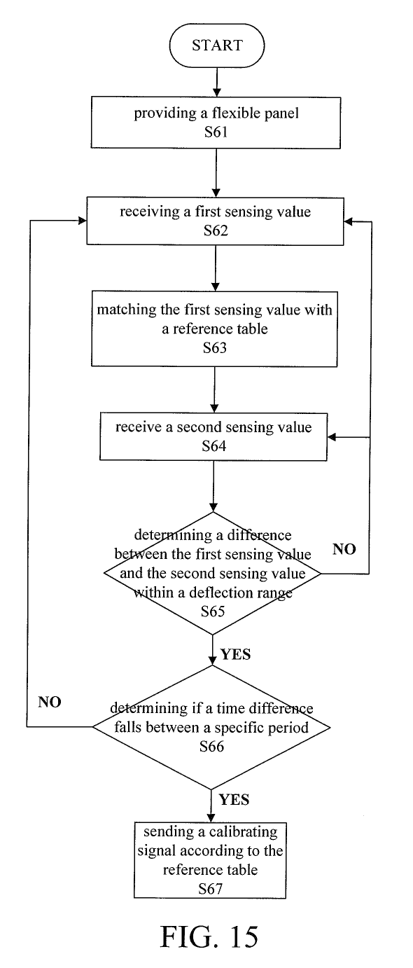

In another embodiment, the present invention can also send the calibrating signal according to the reference table. Please refer to the flowchart in FIG. 15. The method first proceeds to step S61: providing a flexible panel which can be bended to form a specific shape. This step is similar to step S31 and is thus skipped for brevity.

Then the method proceeds to step S62: receiving a first sensing value from at least one sensing device when the flexible panel is bended to form the specific shape. This step is similar to step S32 in FIG. 12 and is thus skipped for brevity.

Then the method proceeds to step S63: matching the first sensing value with a reference table. The reference table is defined by the sensing devices or the flexible panel used in the embodiment; therefore, there could be various reference tables. For example, Table 1 illustrates deflection values received by the sensing devices with respect to the specific shapes in FIG. 7A to FIG. 7C.

TABLE 1

| | | Sensing device | |
|---|---|---|---|
| | sensing device 301c | 302c | sensing device 303c |
| State a | 0 | 0 | 0 |
| (FIG. 7A) | | | |
| State b | 0 | −1 | 0 |
| (FIG. 7B) | | | |
| State c | −0.5 | −0.5 | 0.5 |
| (FIG. 7C) | | | |

Table 2 illustrates different calibrations A-C with respect to specific shapes (state a-c).

TABLE 2

| | | | |
|---|---|---|---|
| | misclick | | |
| sensitivity | filtering | touch point offset | don't-care |

| | |
|---|---|
| State a | Calibrated according to A |
| State b | Calibrated according to B |
| State c | Calibrated according to C |

In addition to using reference table(s) to send out the calibrating signal, the present invention can further take a time factor into consideration to adjust the calibrating signal. After step S63, the method can further receive a second sensing value after a specific period (S64). This step is similar to step S33 in FIG. 12 and is thus skipped for brevity.

The following step S65 is the same as that described in step S34. However, the difference between S65 and S34 is that, when the decision is “yes” in S65, the method proceeds to S66.

Step S66: determining if a time difference between the first sensing value and the second sensing value falls between a specific period, such as 0 to 20 seconds; if “yes”, then the process continues to step S67: sending a calibrating signal according to the reference table. In other words, if the time difference between the first sensing value and the second sensing value is too long, then the first sensing value is invalid, so when the decision is “no” in step S66, the method returns to step S62: receiving the first sensing value once again.

In step S67: sending a calibrating signal according to the reference table, then the processor can cause the electronic device 1 to execute the specific functional mode according to the calibrating signal.

Therefore, when the sensing values obtained by the sensing devices are the same as those in Table 1, which means the flexible panel is formed in the specific shape, then a calibrating signal is generated according to Table 2 and is transmitted to the processor so as to execute the specific functional mode. Moreover, the calibrating signal generated by the reference table can be used for calibrating the flexible panel with respect to the inner touch settings of the original touch plane and the curved surface to cause the electronic device 1 to execute the specific functional mode correctly.

For example, when a user bends the flexible panel into a U shape or a cylindrical shape to fit on his/her wrist, then the flexible panel might sense an error signal when the user inadvertently presses the flexible panel against a table.

In another example, when the flexible panel is bended to form an arc shape, the touch point(s) of the user must be calibrated, since there are touch point offsets on the curved surface.

Similar to FIG. 14A or FIG. 14B, when the flexible panel is bended, there could be different deflections in different regions of the flexible panel; therefore, the present invention further determines if there is a overlapping region and assigns different setting values. For example, in the overlapping region in FIG. 14A or FIG. 14B, the sensitivity setting should be reduced, the misclick function should be turned off, and any touch operations detected in the overlapping area 41 should be ignored.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An electronic device comprising:
a flexible panel capable of forming a specific shape;
at least one sensing device electrically coupled with the flexible panel, the at least one sensing device being provided for detecting a shape of the flexible panel;
a storage device electrically coupled with the flexible panel and the at least one sensing device, the storage device storing a corresponding table, wherein the corresponding table comprises a corresponding relationship between the specific shape of the flexible panel and a specific functional mode; and
a processor electrically coupled with the at least one sensing device and the storage device;
when the flexible panel is bended to form the specific shape, the processor matches the specific shape with the specific functional mode so as to execute the specific functional mode corresponding to the specific shape.

2. The electronic device as claimed in claim 1 further comprising a display device, a vibrating device, an amplifying device, an image capturing device or a sound input device electrically coupled with the processor, respectively.

3. The electronic device as claimed in claim 1, wherein the specific functional mode comprises a keyboard mode, a mouse mode, a TV mode, a PC monitor mode, a clock mode, a digital frame mode, or a mobile phone mode.

4. The electronic device as claimed in claim 3, wherein the processor generates a corresponding signal according to the corresponding table when the electronic device executes the specific functional mode.

5. The electronic device as claimed in claim 1, wherein the sensing device can be a stress sensing device, an optical sensing device, or a vibration sensing device.

6. The electronic device as claimed in claim 5, wherein the stress sensing device can be a piezoelectric sensing device, a capacitive sensing device, an inductive sensing device, or a resistive sensing device.

7. The electronic device as claimed in claim 1, wherein the specific shape comprises a plane, a U shape, an arc, a corrugated shape, a cylindrical shape, or a bended shape with a specific included angle.

8. The electronic device as claimed in claim 1, wherein the flexible panel is a flexible display panel, and the flexible display panel can be a flexible display, a liquid crystal display (LCD), an organic light emitting diode (OLED) display, an E-paper, or a transparent display.

9. A method for switching multi-functional modes of an electronic device comprising a flexible panel, wherein the flexible panel can be bended to form a specific shape, the method for switching multi-functional modes comprising the following steps:
detecting at least one sensing device to identify the specific shape of the flexible panel of the electronic device; and
matching the specific shape with the multi-functional modes according to a corresponding table so as to execute a specific functional mode, wherein the corresponding table comprises a corresponding relationship between the specific shape of the flexible panel and the specific functional mode, and the specific functional mode executed by the electronic device corresponds to the specific shape according to the corresponding relationship.

10. The method for switching multi-functional modes as claimed in claim 9, wherein the corresponding table comprises the specific shape and the specific functional mode, and the corresponding table determines the specific shape according to a stress value or an electrical signal generated by a stress.

11. The method for switching multi-functional modes as claimed in claim 9, wherein the at least one sensing device can be a stress sensing device, an optical sensing device, or a vibration sensing device, and the stress sensing device can be a piezoelectric sensing device, a capacitive sensing device, an inductive sensing device, or a resistive sensing device.

12. The method for switching multi-functional modes as claimed in claim 9, wherein the specific shape comprises a plane, a U shape, an arc, a corrugated shape, a cylindrical shape, or a bended shape with a specific included angle.

13. The method for switching multi-functional modes as claimed in claim 9, wherein the specific functional mode comprises a keyboard mode, a mouse mode, a TV mode, a PC monitor mode, a clock mode, a digital frame mode, or a mobile phone mode.

14. The method for switching multi-functional modes as claimed in claim 9, wherein the processor generates a corresponding signal according to the corresponding table when the electronic device executes the specific functional mode.

15. The method for switching multi-functional modes as claimed in claim 9, wherein the flexible panel can be an independent input device which transmits a signal to the electronic device using wireless or wired transmission techniques.

16. The method for switching multi-functional modes as claimed in claim 9, wherein the flexible panel is a flexible display panel, and the flexible display panel can be a flexible display, a liquid crystal display (LCD), an organic light emitting diode (OLED) display, an E-paper, or a transparent display.

17. The method for switching multi-functional modes as claimed in claim 9 further comprising:
receiving a first sensing value from the at least one sensing device when the flexible panel is bended to form the specific shape;
receiving a second sensing value from the at least one sensing device when the flexible panel is bended for a specific period;
determining if a difference between the first sensing value and the second sensing value is within a deflection range;
if “yes”, then sending a calibrating signal so as to execute the specific functional mode according to the calibrating signal.

18. The method for switching multi-functional modes as claimed in claim 17, wherein the calibrating signal comprises a sensitivity signal, a misclick filtering signal, a touch point offset signal, or an ignored signal.

19. The method for switching multi-functional modes as claimed in claim 9 further comprising:
receiving a first sensing value from the at least one sensing device when the flexible panel is bended to form the specific shape;
matching the first sensing value with a reference table; and
sending a calibrating signal according to the reference table so as to execute the specific functional mode according to the calibrating signal.

20. The method for switching multi-functional modes as claimed in claim 19 further comprising:
determining if the specific shape of the flexible panel has an overlapping area; and
if “yes”, then adjusting the calibrating signal.
